(19) United States
(12) Patent Application Publication
(10) Pub. No.: US 2017/0004543 A1
(43) Pub. Date: Jan. 5, 2017

(54) AUTOMATIC APPROVAL OF ADVERTISEMENTS FOR A SOCIAL NETWORKING SYSTEM

(71) Applicant: Linkedln Corporation, Mountain View, CA (US)

(72) Inventors: Venkata S.J.R. Bhamidipati, Fremont, CA (US); Anil Kumar Gupta, Bangalore (IN); Zhifeng Deng, Mountain View, CA (US)

(21) Appl. No.: 14/788,554

(22) Filed: Jun. 30, 2015

(51) Int. Cl. G06Q 30/02; G06Q 50/00

(52) U.S. Cl. CPC G06Q 30/0276; G06Q 50/01; G06Q 30/0242

(57) ABSTRACT

A social networking system receives an advertisement from a user for posting on the system. The system verifies that the advertisement meets a first set of criteria, and in response to verifying that the advertisement meets the first set of criteria, the system receives a submission of the advertisement from the user for further processing. The system then verifies that the advertisement meets a second set of criteria, and in response to verifying that the advertisement meets the second set of criteria, the system immediately approves the advertisement for display on the system.

### TECHNICAL FIELD

The current disclosure relates to accepting, reviewing, approving, and placing advertisements on a social networking system, and in an embodiment, but not by way of limitation, accepting, reviewing, approving, and placing the advertisements on the social networking system automatically in real time or near real time.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, All Rights Reserved.

### BACKGROUND

A social network service is a computer- or web-based application that enables users to establish links or connections with persons for the purpose of sharing information with one another. Some social networks aim to enable friends and family to communicate with one another, while others are specifically directed to business users with a goal of enabling the sharing of business information. For purposes of the present disclosure, the terms “social network” and “social network service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social network services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social network services in use today, the personal information that is commonly requested and displayed includes a member's age, gender, interests, contact information, home town, address, the name of the member's spouse and/or family members, a photograph of the member, and so forth. With certain social network services, such as some business network services, a member's personal information may include information commonly included in a professional resume or curriculum vitae, such as information about a person's education, employment history, job skills, professional organizations, and so forth. With some social network services, a member's profile may be viewable to the public by default, or alternatively, the member may specify that only some portion of the profile is to be public by default with the entire profile only viewable by a select set of persons to whom the member has granted the appropriate authority. As such, many social network services serve as a sort of directory of people to be searched and browsed.

A social networking system, like most social networking systems and/or websites, accepts advertisements for a fee and displays those advertisements on its system or website. Upon submission of an advertisement by an advertiser, the social networking system or website must review the advertisement to determine if it meets the standards of the social networking system or website. This review process can delay the approval and presentation of the advertisement, especially if one or more problems are identified with the advertisement. This delay is particular a problem for time sensitive advertisements.

### SUMMARY

A social networking system receives an advertisement from a user for posting on the social networking system, and the system verifies that the advertisement meets a first set of criteria. In response to verifying that the advertisement meets the first set of criteria, the social networking system then receives a submission of the advertisement from the user for further processing. The system verifies that the advertisement meets a second set of criteria, and in response to verifying that the advertisement meets the second set of criteria, the system immediately approves the advertisement for display on the social networking system.

### BRIEF DESCRIPTION OF THE DRAWINGS

Some embodiments are illustrated by way of example and not limitation in the figures of the accompanying drawings.

FIG. 1 is a block diagram of the functional modules or components that comprise a computer-network based social network system or service, including application server modules consistent with some embodiments of the invention;

FIG. 2 is a block diagram depicting some example application server modules of FIG. 1;

FIG. 3 is a block diagram illustrating a high level relationship in an advertisement pre-creation phase.

FIGS. 4A, 4B, and 4C illustrate user interfaces in an advertisement pre-creation phase.

FIG. 5 is a block diagram illustrating operations for launching an advertising campaign after passing checks of first set of criteria;

FIG. 6 is a block diagram illustrating communications between a content validation module and several advertisement validation modules;

FIG. 7 is a block diagram illustrating operations of an automatic advertisement approval system as the system determines spam content of an advertisement and the reputation of a member and/or advertiser;

FIGS. 8A and 8B are a flow diagram illustrating an example method of accepting, reviewing, approving, and placing advertisements on a social networking system automatically in real time or near real time; and

FIG. 9 is a block diagram of a computer and network system in connection with which one or more of the disclosed embodiments can operate.

### DETAILED DESCRIPTION

Example methods and systems are directed to accepting, reviewing, approving, and placing advertisements on a social networking system. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

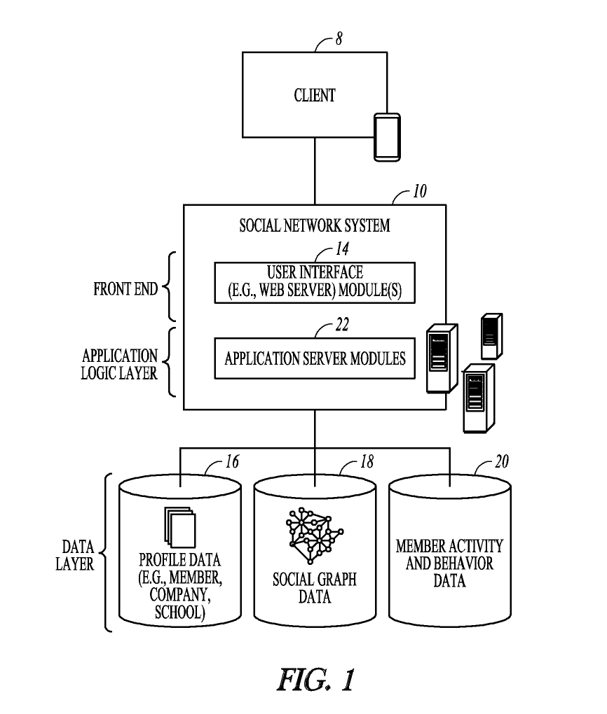

FIG. 1 is a block diagram of the functional modules or components that comprise a computer-based or network-based social network service 10 consistent with some embodiments of the invention. As shown in FIG. 1, the social network system 10 is generally based on a three-tiered architecture, comprising a front-end layer, application logic layer, and data layer, and is in communication with a client device 8. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social network system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end comprises a user interface module (e.g., a web server) 14, which receives requests from various client-computing devices 8, and communicates appropriate responses to the requesting client devices. For example, the user interface module(s) 14 may receive requests in the form of Hypertext Transport Protocol (HTTP) requests, or other web-based, application programming interface (API) requests. The client devices 8 may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the social network service, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's profile, for example, in the database with reference number 16. With some embodiments, a member's profile data will include not only the explicitly provided data, but also any number of derived or computed member profile attributes and/or characteristics.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments a social graph data structure may be implemented with a graph database 18, which is a particular type of database that uses graph structures with nodes, edges, and properties to represent and store data. In this case, the social graph data stored in database 18 reflects the various entities that are part of the social graph, as well as how those entities are related with one another.

With various alternative embodiments, any number of other entities might be included in the social graph, and as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the social network service may include one or more activity and/or event tracking modules, which generally detect various user-related activities and/or events, and then store information relating to those activities/events in the database with reference number 20. For example, the tracking modules may identify when a user makes a change to some attribute of his or her member profile, or adds a new attribute. Additionally, a tracking module may detect the interactions that a member has with different types of content. Such information may be used, for example, by one or more recommendation engines to tailor the content presented to a particular member, and generally to tailor the user experience for a particular member.

The application logic layer includes various application server modules 22, which, in conjunction with the user interface module(s) 14, generates various user interfaces (e.g., web pages) with data retrieved from various data sources in the data layer. With some embodiments, individual application server modules 22 are used to implement the functionality associated with various applications, services and features of the social network service. For instance, a messaging application, such as an email application, an instant messaging application, or some hybrid or variation of the two, may be implemented with one or more application server modules 22. Of course, other applications or services may be separately embodied in their own application server modules 22.

The social network service may provide a broad range of applications and services that allow members the opportunity to share and receive information, often customized to the interests of the member. For example, with some embodiments, the social network service may include a photo sharing application that allows members to upload and share photos with other members. As such, at least with some embodiments, a photograph may be a property or entity included within a social graph. With some embodiments, members of a social network service may be able to self-organize into groups, or interest groups, organized around a subject matter or topic of interest. Accordingly, the data for a group may be stored in a database (not shown). When a member joins a group, his or her membership in the group will be reflected in the social graph data stored in the database with reference number 18. With some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data of the database with reference number 18.

FIG. 2 is a block diagram depicting some example application server modules 22 of FIG. 1. A data collection module 202 may be configured to collect advertisement data corresponding to an advertiser in a social network system. Such data may include the content of the advertisement itself, and also may include profile data, behavior data, and social network data. An advertisement examination module 204 may be configured to examine advertisements submitted by advertisers and to determine whether such advertisements meet certain criteria, as will be discussed in more detail below. A user interface presentation module 208 may be configured to generate a user interface for presentation to the user (i.e., a member or an advertiser). The user interface may include information pertaining to submitted, examined, approved, and/or rejected advertisements.

A goal of an embodiment of the present disclosure is to automatically approve an advertisement for posting on a social networking system in real time or near real time. Such a feature will address the problem previously outlined above wherein a user submits an advertisement to a social networking system, and the advertisement has one or more issues with it that prevent the advertisement from being posted without addressing those issues. In the past, when such issues were present, such issues were not addressed until sometime later (e.g., twenty four hours later). Such a prior system was particular a problem for time sensitive advertisements, such as marketing or sales offers limited to a relatively short time period (e.g., twenty four hours). Another goal of an embodiment is to approve a certain percentage of advertisements automatically. Such an automatic approval may be based on the reputation of an advertiser.

One or more embodiments improve the functionality of such a computer-based social networking system by receiving an advertisement from a user for posting on the social networking system, and verifying that the advertisement meets a first set of criteria. In response to verifying that the advertisement meets the first set of criteria, the system then receives a submission of the advertisement from the user for further processing. The system then verifies that the advertisement meets a second set of criteria, and in response to verifying that the advertisement meets the second set of criteria, the system immediately approves the advertisement for display and/or placement on the social networking system.

The changes to implement these improvements in the functionality of processing advertisements for a social network system can span over multiple parts of the social networking system in general, and advertisement processing for the social networking system in particular. For example, the changes in all likelihood will affect frontend advertisement modules, backend advertisement modules, content validation modules (e.g., a content decision engine), a content spam classifier module, a content relevance/quality classifier module, a media scan module (e.g., to detect viruses, nudity, etc), a URL validator module, a frontend review queue, and a backend review queue. These modules will be discussed in detail below in connection with one or more embodiments.

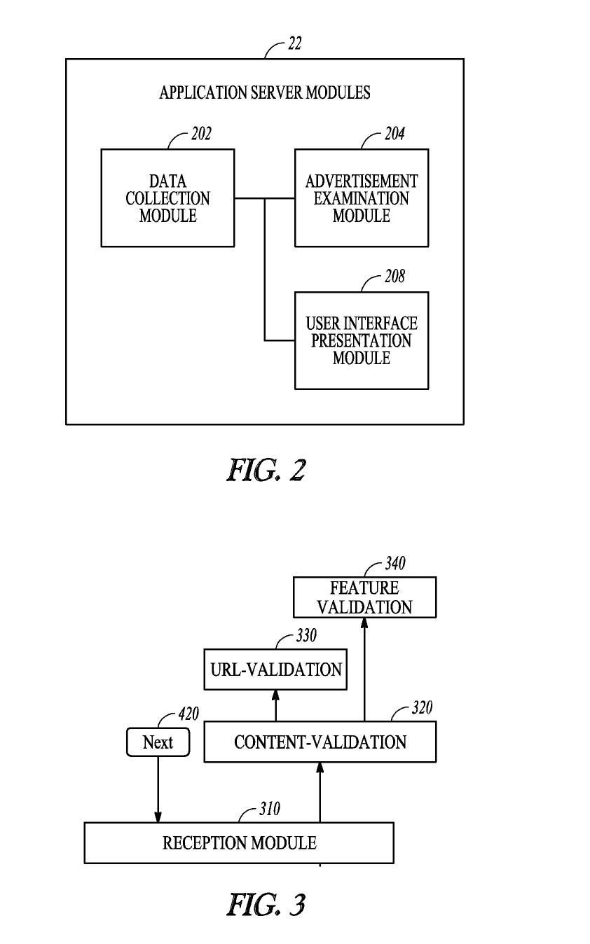

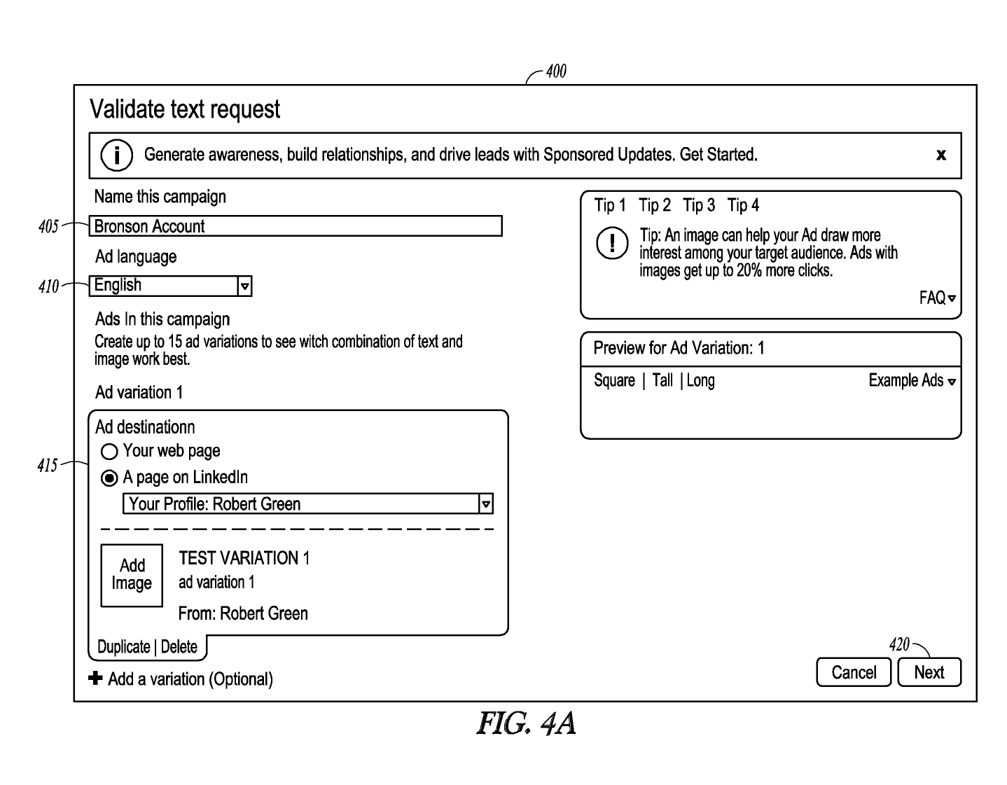

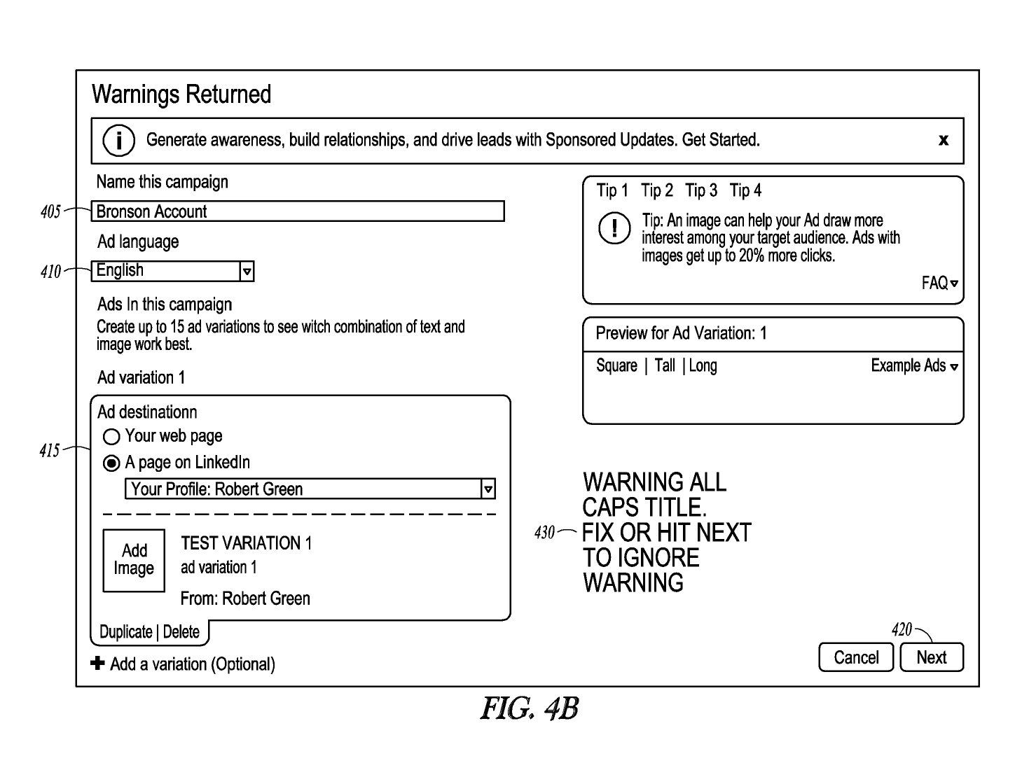

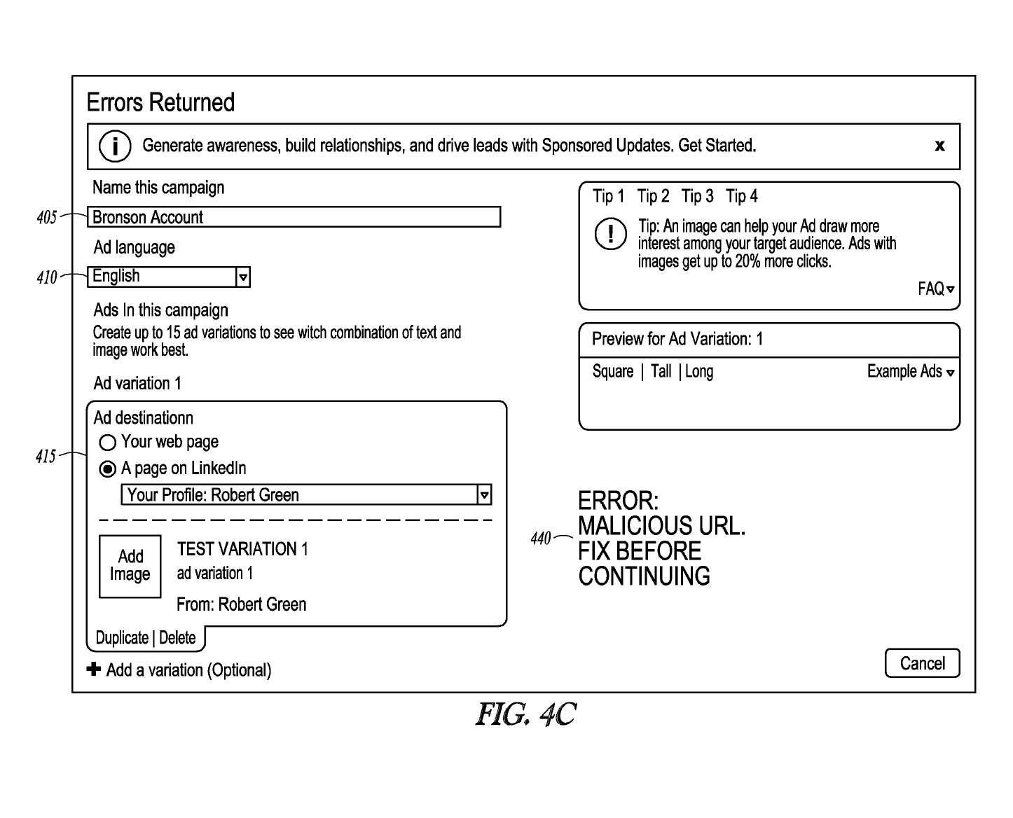

The overall architecture of the system can be divided into an advertisement pre-creation section and an advertisement creation section. FIGS. 3, 4A, 4B, and 4C illustrate the pre-creation phase. FIG. 4A illustrates a user interface in the pre-creation phase. The user interface 400 permits a user to assign a name to the user's advertisement or advertisement campaign at 405, to specify a language for the advertisement at 410, and to create multiple variations of the advertisement at 415. FIG. 3 illustrates a high level relationship in the advertisement pre-creation phase. Before an advertisement is persisted in an advertisement database, a reception module 310 receives the data from the proposed advertisement, and a content validation module 320 is called by the reception module 310. The reception module 310 receives the data for the advertisement when an advertiser selects the next button 420. The reception module 310 transmits to the content validation module 320 such items as the title of the advertisement, the body of the advertisement, whether the advertisement is a first pre-creation or an update to an immediately prior pre-creation (e.g., when a user corrects an advertisement in response to problematic initial or first criteria), an advertiser identification, a member identification, the language chosen by the user for the advertisement, and a URL of the target for the advertisement. The content validation module 320 works with a URL validation module 330 and a feature validation module 340. The URL validation module 330 determines whether the target URL or any URL within the advertisement contains a malicious link. If so, the user is informed that such URLs are blocked. The feature validation module 340 relates to such issues as language mismatches and capitalization of the advertisement. A language mismatch occurs when the user selects a first language at 410, but the feature validation module 340 detects a different language in the advertisement. A capitalization issue arises when there is an improper mixture of upper and lower cases characters in the advertisement, or there are simply too many upper case characters in the advertisement. The feature validation module 340 can also determine whether there is any improper language in the advertisement such as profanity. In an embodiment, the content validation module 320 runs the input, classification results, and URL validation results through a scorer that makes a decision on whether the content of the advertisement is spam (based on a URL) or is a low quality advertisement (based on results from a cyclic redundancy check (CRC)). Top level spam and low quality flags are used in conjunction with the spam and low quality explanations to provide a warning or an error to the user interface.

FIG. 4B illustrates an example user interface where a warning is returned at 430. FIG. 4C illustrates an example user interface where an error is returned at 440.

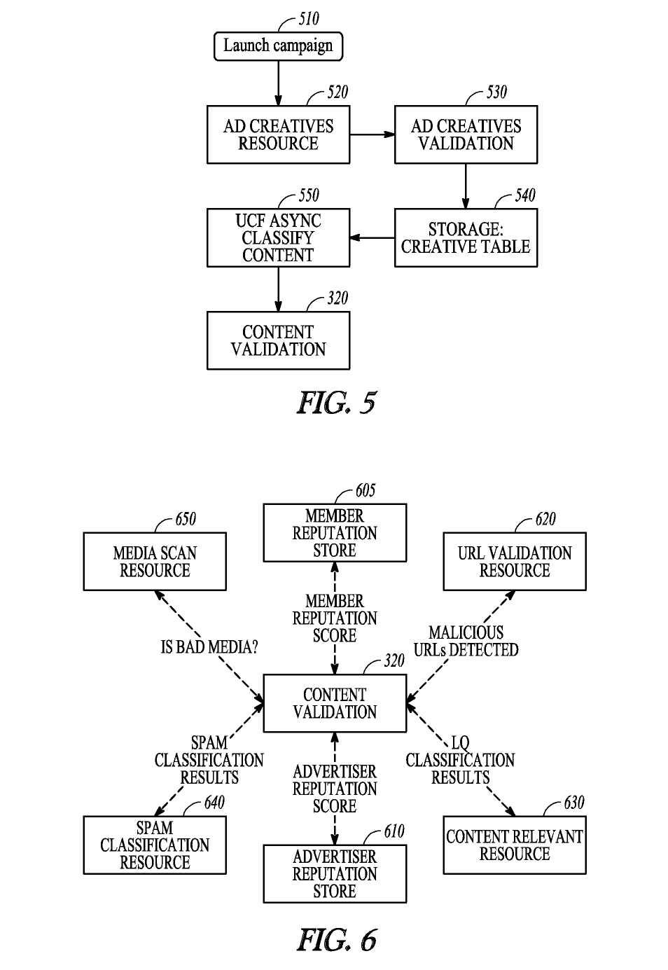

If the advertisement passes the checks in the pre-creation phase, the system enters the advertisement creation phase. As illustrated in FIG. 5, after passing the checks of the first set of criteria in the pre-creation phase, the user is given the option to launch the advertisement campaign at 510. An advertisement creation resource module 520 is called for each variation of the advertisement submitted by the user. The advertisement creation resource module 520 provides an ability to search by any combination of a plurality of fields in an advertisement table, such as a CreativeId, an Advertiserld, a CampaignUrn, a CreativeType, a ReviewStatus, a CreatorlD (e.g., a member id), a RejectionCode, inappropriate advertisement content, inappropriate site content, improper language, etc. The advertisement validation occurs at 530, and the advertisement creative is written to an advertisement creatives table database 540. This action generates an advertisement creative id, thereby generating a key to identify the advertisement. After storage, an async classify content module 550 is called with data such as a creative uniform resource name (URN), title of the advertisement, body of the advertisement, an advertiser identification, a member urn, a campaign language, a campaign urn, and target URL. The async classify content module 550 calls the content validation module 320 and supplies to the content validation module the creative record.

As illustrated in FIG. 6, the content validation module 320 is configured to validate several aspects of the advertisement. The content validation module 320 accesses a member reputation store 605 and an advertiser reputation store 610. The reputation score of a member or advertiser is based on past actions and dealings of the member and advertiser on the social networking system. For example, if the advertiser has a history that shows many of its proposed advertisement have been initially and/or finally rejected, then there is a greater chance that a new proposed advertisement for this advertiser will not be automatically accepted.

The content validation module 320 also communicates with a URL validation module 620, which examines a URL that appears in the advertisement to check to see if the URL has a malicious or pernicious nature to it.

The content validation module 320 also communicates with a content relevance resource module 630. The content relevance resource module 630 examines the advertisement to determine the quality of the advertisement, and then rates the advertisement accordingly. For example, the advertisement may have one or more images in it. If the images are too small and/or of poor visual quality, the content relevance resource module 630 will assign a low score or otherwise indicate that the advertisement is of low quality and the user can be informed of such immediately.

The content validation module 320 also communicates with a spam classification module 640. The spam classification module 640 analyzes an advertisement for spam content, using any well known spam detection software such as used for spam detection in the electronic mail environment.

The content validation module 320 also communicates with a media scan module 650. The media scan module 650 determines inappropriate content such as nudity via a computer vision analysis of the content of the advertisement.

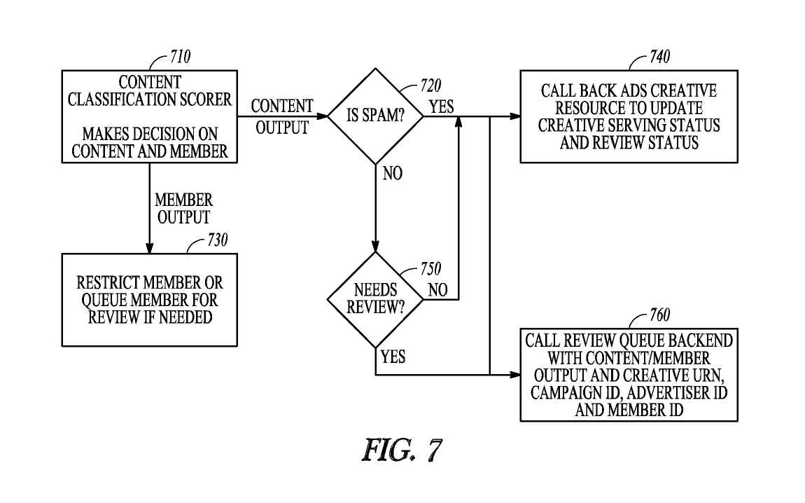

FIG. 7 illustrates the operations of the automatic advertisement approval system as the system determines the spam content of the advertisement and the reputation of the member. The content classifier scorer 710 analyzes the content of the advertisement for spam at 720 and further analyses the reputation of the member at 730. If the message is identified as spam at 720, a back ads creative resource module is called at 740 to update the status of the advertisement and review the status of the advertisement. If the advertisement was not identified as spam at 720, it is still determined whether the advertisement needs review at 750, and if review is needed, at 760, a backend review queue is called with the content and member and also the creative urn, the campaign id, the advertiser id, and the member id.

Throughout the classification process, a unique id is given to the advertisement or content, and this id remains unchanged throughout the classification process and for any subsequent classification. There are also a member id and a session id, which indicate who created the content and in which session the content was created. A country code is also assigned to the content, which indicates the country in which the content was created. In an embodiment, the media scan, CRC, and URL validations are done online, whereas the advertiser reputation and member reputation are performed offline.

In an embodiment, a review items table maintains the state of the review of an advertisement (e.g., pending, escalated, closed, etc.). For a pending advertisement, a decision has not yet been made as to whether to approve the advertisement for posting. For an escalated advertisement, the advertisement has been tagged as needing further review, perhaps by a human. For a closed advertisement, the advertisement is no longer being considered for posting on a social networking system. An advertisement table maintains the status of the content of the advertisement (e.g., approved, rejected, auto-approved, review-pending, etc). An advertisement is auto-approved based on the reputation of the advertiser, as explained in more detail below. The review items table also contains content (called the target), an assignee, and other needed metadata. The review queue framework provides an ability to search pending, escalated, and closed reviews for a particular user. The system also provides the ability to search for all approved advertisements, all advertisements by a particular advertiser, or a particular advertising campaign.

Whenever a user loads the advertisement review queue that is associated with the user (e.g., a person who reviews advertisements), a review items table provides a list of items assigned to this user. Content and creator information can be retrieved for each review item by calling an advertisements restli resource with respective URNs. Whenever a user acts on a review item and modifies the state of the content, an advertisement resource module is called and the item may be marked as closed in the review items table. In an embodiment, there is a periodic sync job running in the review queue backend that keeps polling an advertisement backend module to determine if all items that are in a review pending state are also open items in the review queue. This feature prevents an advertisement from forever remaining in a pending state in case that the review items table is not written to for some reason.

In an embodiment, training data is gathered. The training data includes historical advertisement content and advertisement review records. The purpose of the training is to generate a score threshold for use in determining whether the advertisement meets one or more of the first set of criteria or the second set of criteria. To gather the training data, the system loops over each month of the year. Labels are selected based on the percentage of advertisements accepted in the looped month. For example, a label could be 1 if greater than 98% of the advertisements are accepted in a month, and the label could be 0 if the advertisement acceptance rate is less than <80%. In an embodiment, users with acceptance rates between 80-98% are not considered because such a range does not give a good read on an advertiser's reputation.

With this training, the system can predict whether an advertisement from an advertiser will be automatically accepted, or whether the advertisement from this user will have to be reviewed by a person. As noted, the prediction is based on the history of the advertisements posted by an advertiser as well as based on the profile of the member. Any person with at least one advertisement posted in the previous month will have a reputation score. The factors in an advertisement history can be an absolute number and/or percentage of advertisements accepted and rejected, an average number of clicks for advertisements for the advertiser, an average number of impressions for the advertiser, an average click through rate, an average total budget and budget per advertisement for the advertiser, and the age of the advertiser (e.g., number of days since the first advertisement of the advertiser). The factors for a member profile can include the age of the member (e.g., days since the creation of the member's profile) and the number of connections that the member has.

There are a plurality of factors that are used to determine whether an advertisement will be automatically accepted (or whether it is not automatically accepted and must be reviewed by a person). These factors can be hard coded into the system or the system can learn such rules. Features can be chosen such that the system is able to learn the rules that a reviewer used to reject advertisements (rather than hard coding these rules). Factors include the number of sentences, words, and digits in an advertisement; the number of lower case and upper case characters in the advertisement; the number of ‘!’ ‘?’ and ‘.’ characters in the advertisement; the maximum number of continuous repetitions of ‘!’ ‘?’ and ‘.’ characters in the advertisement; a count of words that have all upper case letters in the advertisement; the longest length of all upper case words occurring together in the advertisement; a list of all upper case words in the advertisement; URLs, email addresses, and phone numbers in the advertisement; a detected language in the advertisement; stopword removal and stemming; and words and their TF-IDF score.

When an advertisement needs to be reviewed, for example based on the reputation of the advertiser, the advertisement is placed in an advertisement review queue. A process in the advertisement review queue backend listens for this event. When the review status is in a pending state, the system ignores the event. Otherwise, the advertisement goes through the UCF async classify content module 550 in an async flow and it is decided whether the advertisement needs a review or not. The module 550 marks the state in the database as “needs review” or “auto-approved.” The system listens for this event, and inserts an entry in the database if the advertisement needs review; otherwise, the system ignores the event. The review queue has a placeholder for including the business logic to fetch the advertisement. The oldest advertisement is pulled, the advertiser for this advertisement is retrieved, and all advertisements for this advertiser are retrieved and presented to the reviewer. The reviewer takes an action—that is, the reviewer either approves the advertisement, rejects the advertisement, or escalates the advertisement. If the advertisement is approved or rejected, the advertisement database is updated and the advertisement is marked as closed in the database. If the advertisement is escalated, then the state of the advertisement is changed to “escalated” and the advertisement is shown to another person (i.e., a manager or supervisor).

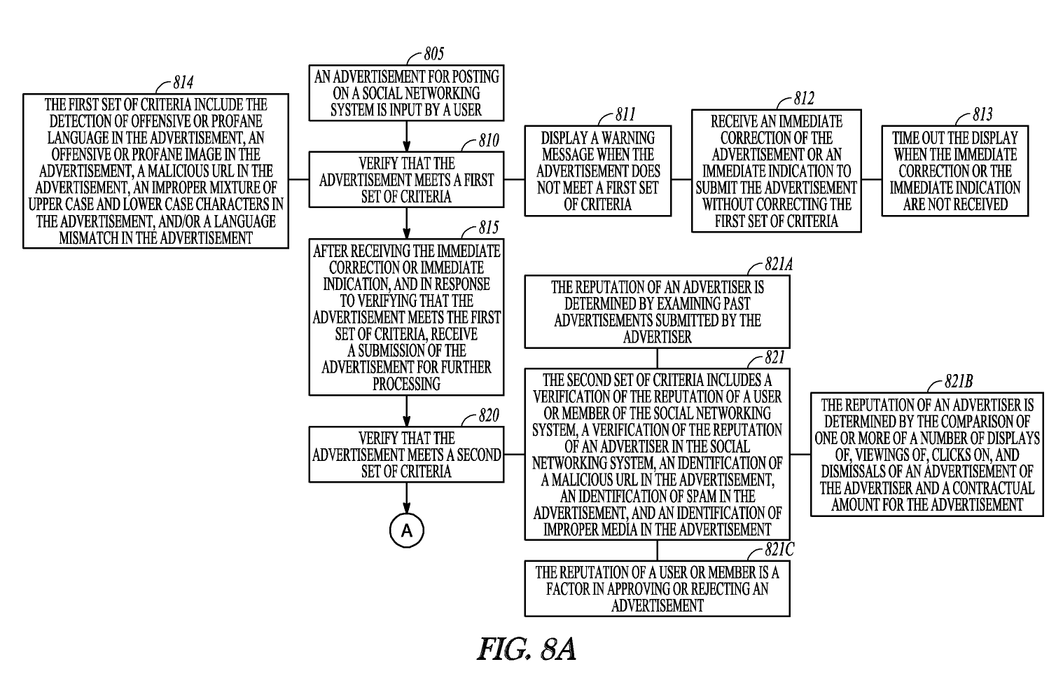

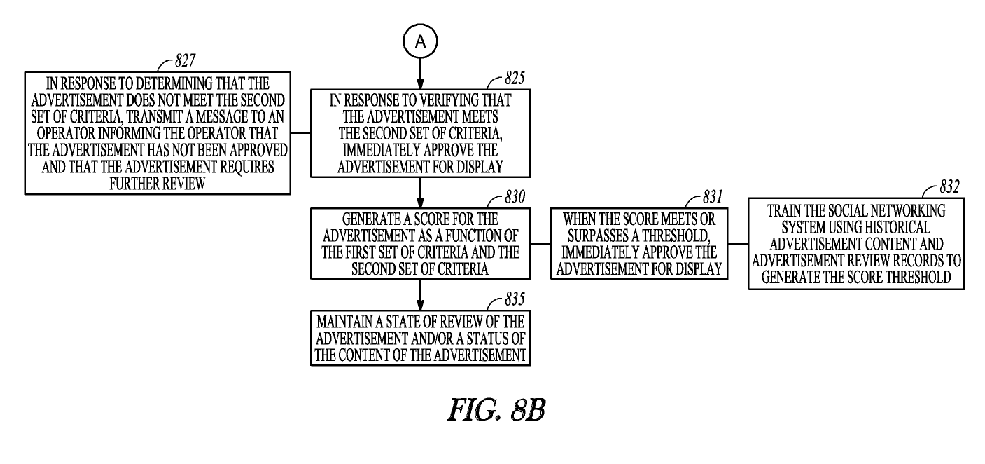

FIGS. 8A and 8B are a flow diagram illustrating an example method 800 of accepting, reviewing, approving, and placing advertisements on a social networking system automatically in real time or near real time. In various embodiments, the method 800 may be implemented by one or more of the modules of FIG. 2. FIGS. 8A and 8B include a number of process blocks 805-835. Though arranged serially in the example of FIGS. 8A and 8B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 8A and 8B, at 805, a social networking system receives an advertisement that is input by a user. The advertisement is for posting on the social networking system. At 810, the social networking system verifies that the advertisement meets a first set of criteria. If the advertisement does not meet this first set of criteria, then at 811, the social networking system displays a warning to the user. At 812, the social networking receives an immediate correction of the advertisement from the user or an immediate indication from the user to submit the advertisement without correcting the first set of criteria. At 813, the social networking system times out the display when the immediate correction or the immediate indication are not received from the user. Consequently, in the context of this disclosure, the term “immediately” means a reasonable time period in the art of computer-human interaction. For example, the time out period could be set to one minute. The details of the first set of criteria in and of themselves, in an embodiment, are discussed below.

At 815, after receiving the immediate correction or immediate indication from the user, and in response to verifying by the social networking system that the advertisement meets the first set of criteria, the social networking system receives a submission of the advertisement from the user for further processing. At 820, this further processing entails verifying that the advertisement meets a second set of criteria. The details of the second set of criteria, in an embodiment, are discussed below. At 825, in response to verifying that the advertisement meets the second set of criteria, the social networking system immediately approves the advertisement for display on the social networking system. In this instance, the term “immediately” means a typical time period in the art of computer processing, such as within a few seconds. Alternatively, as indicated at 827, in response to determining that the advertisement does not meet the second set of criteria, the social networking system transmits a message to an operator informing the operator that the advertisement has not been approved and that the advertisement requires further review.

The first set of criteria can include the detection of one or more of the following—offensive or profane language in the advertisement, an offensive or profane image in the advertisement, a malicious URL in the advertisement, an improper mixture of upper case and lower case characters in the advertisement, and a language mismatch in the advertisement (814). The offensive or profane language can be detected by comparing the text in the advertisement to a simple database of terms that are considered profane or offensive. An offensive image can be detected, for example, using computer vision technology to identify a human in the image, and to determine that the image has a single flesh tone over the entire body or substantially the entire body, indicating that the human in the image is potentially in the nude. The malicious URL in the advertisement can be detected by comparison against a database of known malicious URLs, and/or accessing the URL in a test or sandbox environment, and analyzing the access to determine if there is a malicious aspect to the URL. The determination of an improper mixture of upper and lower case characters in the advertisement can be determined in several ways. For example, a simple check of the text in the advertisement can be made to verify only the first letter in any word is in upper case, and that only a small percentage of words within the midst of a sentence or phrase begin with an upper case character. A language mismatch occurs in systems wherein a user is allowed to indicate at set up time the language that the advertisement is in (English, Spanish, French, etc.), and a verification that the language in the advertisement is in that language.

The second set of criteria can include a verification of the reputation of a user or member of the social networking system, a verification of the reputation of an advertiser in the social networking system, an identification of a malicious URL in the advertisement, an identification of spam in the advertisement, and an identification of improper media in the advertisement (821). In an embodiment, the reputation of an advertiser can be determined by examining past advertisements submitted to the social networking system by the advertiser (821A). If the advertiser has a high percentage of advertisements that have been accepted and posted on the social networking system, then the advertiser has a good reputation, and an automatic or other fast track approval is more likely. Additionally, the reputation of an advertiser can be determined by the comparison of one or more of a number of displays of, viewing s of, clicks on, and dismissals of an advertisement of the advertiser and a contractual amount for the advertisement (821B). For example, if an advertiser has contracted to pay a certain maximum amount for an advertisement based on a number of clicks on the advertisement, but the advertiser receives more clicks than the contracted amount (because for example the system has not yet detected the surplus clicks), this can affect the reputation of the advertiser. As indicated at 821C, an advertiser can also be a user or member of the social networking system, and the reputation of the entity as a user or member can also be a factor in approving or rejecting an advertisement. The social networking system can also seek to determine whether there is any spam in the advertisement, for example, by using any spam-detecting techniques and/or algorithms known in the email art. As can be seen, the second set of criteria, like the first set of criteria, can include determinations of a malicious URL in the advertisement and/or improper media (e.g., nudity) in the advertisement. Since malicious URLs and improper media can be considered a particularly important issue, the analysis of the advertisement for these in the second set of criteria can serve as a second check.

In an embodiment, as indicated at 830, the social networking system generates a score for the advertisement as a function of the first set of criteria and the second set of criteria. Then, at 831, when the score meets or surpasses a threshold, the social networking system immediately approves the advertisement for display on the social networking system. As noted above, the immediate approval of an advertisement is particularly appropriate for time sensitive advertisements such as promotions that are in effect for only “the next twenty-four hours.” In a further embodiment, as indicated at 832, the social networking system can be trained using historical advertisement content and advertisement review records to generate the score threshold for use in determining whether the advertisement meets one or more of the first set of criteria or the second set of criteria. For example, the content of advertisements that have been previously approved can be stored in a database, and if a newly proposed advertisement includes the same or similar content, this can be used as a factor in determining whether the advertisement meets the criteria or in the calculation of the score. Similarly, advertisement review records contain data relating to a human review of an advertisement, and these data can also be used in the calculation of the score or a determination of whether the first or second set of criteria has been met.

At 835, the social networking system maintains a state of review of the advertisement and/or a status of the content of the advertisement. The state of review, as noted above, can include states such as “pending,” “approved,” and/or “rejected.” The status of the content can relate to, for example, a “waiting” status as the social networking system attempts to determine whether an advertisement includes inappropriate media such as nudity.

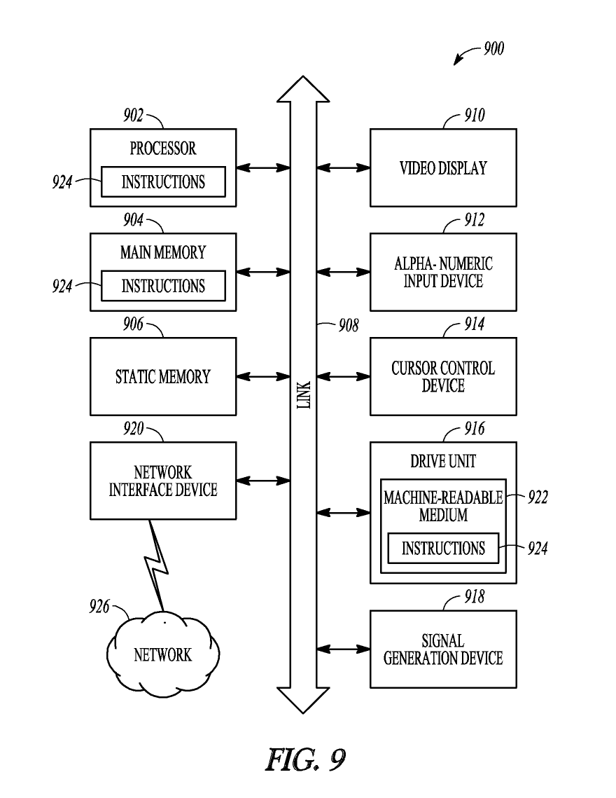

FIG. 9 is a block diagram illustrating components of a machine 900, according to some example examples, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system and within which instructions 924 (e.g., software) for causing the machine 900 to perform any one or more of the methodologies discussed herein may be executed. In alternative examples, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The machine 900 may further include a graphics display 910 (e.g., a plasma display panel (PDP), a light emitting diode (LED) display, a liquid crystal display (LCD), a projector, or a cathode ray tube (CRT)). The machine 900 may also include an alphanumeric input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a speaker), and a network interface device 920.

The storage unit 916 includes a machine-readable medium 922 on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, during execution thereof by the machine 900. Accordingly, the main memory 904 and the processor 902 may be considered as machine-readable media. The instructions 924 may be transmitted or received over a network 926 via the network interface device 920.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 900), such that the instructions, when executed by one or more processors of the machine (e.g., processor 902), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A social networking system comprising:
a computer processor and a computer database configured to:
receive an advertisement from a user for posting on the social networking system;
verify that the advertisement meets a first set of criteria;
in response to verifying that the advertisement meets the first set of criteria, receive a submission of the advertisement from the user for further processing;
verify that the advertisement meets a second set of criteria; and
in response to verifying that the advertisement meets the second set of criteria, immediately approve the advertisement for display on the social networking system;
wherein the second set of criteria comprises a reputation of the user;
wherein the user has contracted to pay a maximum amount for the advertisement based on a contractual number of clicks on the advertisement; and
wherein a determination of the reputation of the user comprises a comparison of the contractual number of clicks on the advertisement and an actual number of clicks on the advertisement, such that the reputation of the user is affected when the actual number of clicks on the advertisement exceeds the contractual number of clicks on the advertisement.

2. The social networking system of claim 1, wherein the computer processor is configured to display a warning on the social networking system when the advertisement does not meet the first set of criteria; and to receive an immediate correction of the advertisement from the user or an immediate indication from the user to submit the advertisement without correcting the first set of criteria.

3. The social networking system of claim 2, wherein the computer processor is configured to time out the display when the immediate correction and the immediate indication are not received.

4. The social networking system of claim 1, wherein the first set of criteria comprises one or more of detecting offensive or profane language in the advertisement, detecting an offensive or profane image in the advertisement, detecting a malicious URL in the advertisement, detecting an improper mixture of upper case and lower case characters in the advertisement, and detecting when there is a language mismatch in the advertisement.

5. The social networking system of claim 1, wherein the second set of criteria comprises one or more of verifying a reputation of a member of the social networking system, verifying a reputation of an advertiser in the social networking system, identifying a malicious URL in the advertisement, identifying spam in the advertisement, and identifying improper media in the advertisement.

6. The social networking system of claim 5, wherein the member and the advertiser are the same entity.

7. The social networking system of claim 5, wherein the computer processor is configured to determine the reputation of an advertiser by determining a percentage of advertisements accepted from the advertiser over a particular time period.

8. (canceled)

9. The social networking system of claim 1, wherein the computer processor is configured to generate a score for the advertisement as a function of the first set of criteria and the second set of criteria, and to immediately approve the advertisement for display on the social networking system as a function of the score.

10. The social networking system of claim 1, wherein the computer processor is trained using historical advertisement content and advertisement review records to generate a score threshold for use in determining whether the advertisement meets one or more of the first set of criteria or the second set of criteria.

11. The social networking system of claim 1, wherein the computer processor is configured to maintain a state of review of the advertisement and a status of the content of the advertisement.

12. The social networking system of claim 1, wherein the computer processor is configured to, in response to determining that the advertisement does not meet the second set of criteria, transmit a message to an operator informing the operator that the advertisement has not been approved and that the advertisement requires further review.

13. A machine-readable medium comprising instructions that when
executed by a processor execute a process comprising:
receiving an advertisement from a user for posting on a social networking system;
verifying that the advertisement meets a first set of criteria;
in response to verifying that the advertisement meets the first set of criteria, receiving a submission of the advertisement from the user for further processing;
verifying that the advertisement meets a second set of criteria; and
in response to verifying that the advertisement meets the second set of criteria, immediately approving the advertisement for display on the social networking system;
wherein the second set of criteria comprises a reputation of the user;
wherein the user has contracted to pay a maximum amount for the advertisement based on a contractual number of clicks on the advertisement; and
wherein a determination of the reputation of the user comprises a comparison of the contractual number of clicks on the advertisement and an actual number of clicks on the advertisement, such that the reputation of the user is affected when the actual number of clicks on the advertisement exceeds the contractual number of clicks on the advertisement.

14. The machine readable medium of claim 13, comprising instructions for displaying a warning on the social networking system when the advertisement does not meet the first set of criteria; and for receiving an immediate correction of the advertisement from the user or an immediate indication from the user to submit the advertisement without correcting the first set of criteria; and for timing out the displaying when the immediate correction and the immediate indication are not received.

15. The machine readable medium of claim 13, wherein the first set of criteria comprises one or more of detecting offensive or profane language in the advertisement, detecting an offensive or profane image in the advertisement, detecting a malicious URL in the advertisement, detecting an improper mixture of upper case and lower case characters in the advertisement, and detecting when there is a language mismatch in the advertisement; and
wherein the second set of criteria comprises one or more of verifying a reputation of a member of the social networking system, verifying a reputation of an advertiser in the social networking system, identifying a malicious URL in the advertisement, identifying spam in the advertisement, and identifying improper media in the advertisement.

16. (canceled)

17. The machine readable medium of claim 13, comprising instructions for generating a score for the advertisement as a function of the first set of criteria and the second set of criteria, and for immediately approving the advertisement for display on the social networking system as a function of the score.

18. The machine readable medium of claim 13, comprising instructions for training using historical advertisement content and advertisement review records to generate a score threshold for use in determining whether the advertisement meets one or more of the first set of criteria or the second set of criteria.

19. The machine readable medium of claim 13, comprising instructions for, in response to determining that the advertisement does not meet the second set of criteria, transmitting a message to an operator informing the operator that the advertisement has not been approved and that the advertisement requires further review.

20. A process comprising:
receiving an advertisement from a user for posting on a social networking system;
verifying that the advertisement meets a first set of criteria;
in response to verifying that the advertisement meets the first set of criteria, receiving a submission of the advertisement from the user for further processing;
verifying that the advertisement meets a second set of criteria; and
in response to verifying that the advertisement meets the second set of criteria, immediately approving the advertisement for display on the social networking system;
wherein the second set of criteria comprises a reputation of the user;
wherein the user has contracted to pay a maximum amount for the advertisement based on a contractual number of clicks on the advertisement; and
wherein a determination of the reputation of the user comprises a comparison of the contractual number of clicks on the advertisement and an actual number of clicks on the advertisement, such that the reputation of the user is affected when the actual number of clicks on the advertisement exceeds the contractual number of clicks on the advertisement.
